(19) United States
(12) Patent Application Publication
(10) Pub. No.: US 2011/0096533 A1
(43) Pub. Date: Apr. 28, 2011

(54) REFRACTIVE OPTICS TO PROVIDE UNIFORM ILLUMINATION IN A DISPLAY CASE

(76) Inventors: William Sekela, Aurora, OH (US); Mathew Sommers, Sagamore Hills, OH (US); Larry Stadelman, Stow, OH (US); Mark Kaminski, Tucson, AZ (US); Samantha Schultz, Valley View, OH (US)

(21) Appl. No.: 12/913,255

(22) Filed: Oct. 27, 2010

Related U.S. Application Data
(60) Provisional application No. 61/255,287, filed on Oct. 27, 2009.

(51) Int. Cl. A47F 10/02; F21V 21/00; F21S 4/00; F21V 5/00

(52) U.S. Cl. 362/125; 362/217.15; 362/225; 362/217.02

(57) ABSTRACT

A lighting assembly for illuminating a display case, where the lighting assembly is mounted to a display case and includes a visibility envelop within which an onlooker of the display case cannot see. The lighting assembly includes an elongated frame provisioned to receive modular inserts and at least one modular insert operatively connected to the elongated frame. The at least one modular insert includes a light module, where the light module includes an optical lens and a light source. The optical lens is disposed over and/or around the light source and is disposed exclusively within the visibility envelope. The optical lens is fashioned to control light emitted from the light source using refraction and total internal reflection.

### CROSS-REFERENCE TO RELATED APPLICATION

This application claims the benefit of U.S. Provisional Application No. 61/255,287, filed Oct. 27, 2009, incorporated herein by reference in its entirety.

### BACKGROUND

The present exemplary embodiments relate generally to lighting assemblies. They find particular application in conjunction with lighting display cases (e.g., commercial refrigerated display cases), and will be described with particular reference thereto. However, it is to be appreciated that the present exemplary embodiments are also amenable to other like applications.

Lighting assemblies are used to illuminate display cases, such as commercial refrigeration display cases, as well as other display cases that need not be refrigerated. Typically lighting assemblies use a fluorescent tube to illuminate products disposed in a display case. However, fluorescent tubes are being phased out in favor of LED technology.

Fluorescent tubes do not have nearly as long a lifetime as typical LED, and, for at least refrigerated display cases, initiating the required arc to illuminate a fluorescent tube is difficult. Even more, fluorescent tubes are relatively inefficient by comparison to LEDs, since fluorescent tubes produce more heat than LEDs and provide less control over the direction of light.

Known lighting assemblies often suffer from a number of problems when it comes to lighting display cases. As discussed below, these problems may include issues pertaining to efficiency, lighting uniformity, consumer appeal, customization and maintenance.

Lighting assemblies often allow light to escape the display case and bleed out into the external environment. However, this light could be put to better use lighting the item(s) on display, whereby less powerful and/or or fewer light sources could be employed.

Further, lighting assemblies generally do not uniformly light a display case. Namely, such assemblies generally fail to direct enough light to the center of a display case, resulting in much higher luminance in front of a mullion, as compared to the center of the display case. However, uniform luminance is preferable as it makes more efficient use of the available luminance and may allow fewer light sources and/or less powerful light sources.

Additionally, the optics and/or light sources of lighting assemblies are often visible to consumers. However, consumer tests have found it desirable to keep optics and/or light sources of a lighting assembly outside the view of an onlooker of the display case.

Even more, existing lighting assemblies are generally constructed with a fixed configuration in mind, whereby changing the configuration requires a mechanical and/or electrical redesign. However, this can add unnecessary expense when unconventional configurations are needed.

Further, existing lighting assemblies generally lack any way to replace components. When a component fails, the entire lighting assembly generally needs to be replaced. This can prove costly for one operating a large number of light assemblies.

The present disclosure contemplates new and improved systems and/or methods addressing these, and other, problems.

### BRIEF DESCRIPTION

Various details of the present disclosure are hereinafter summarized to provide a basic understanding. This summary is not an extensive overview of the disclosure and is intended neither to identify certain elements of the disclosure, nor to delineate the scope thereof. Rather, the primary purpose of the summary is to present certain concepts of the disclosure in a simplified form prior to the more detailed description that is presented hereinafter.

According to one aspect of the present disclosure, a lighting assembly for illuminating a display case is provided. The lighting assembly includes an elongated frame and a plurality of modular inserts. The modular inserts are removably connected to the elongated frame and include a plurality of light modules. Each of the plurality of light modules is removably coupled to adjacent light modules electrically.

According to another aspect of the present disclosure, a lighting assembly for illuminating a display case is provided. The lighting assembly is mounted to the display case and includes a visibility envelope within which an onlooker of the display case cannot see. The assembly includes a light source and an optical lens disposed over and/or around the light source. The optical lens is disposed exclusively within the visibility envelope and fashioned to control light emitted from the light source using refraction and total internal reflection.

According to another aspect of the present disclosure, a lighting assembly for illuminating a display case is provided. The lighting assembly is mounted to the display case and includes a visibility envelop within which an onlooker of the display case cannot see. The assembly includes an elongated frame provisioned to receive modular inserts and at least one modular insert operatively connected to the elongated frame. The at least one modular insert includes a light module having an optical lens and a light source, where the optical lens is disposed over and/or around the light source and exclusively within the visibility envelope, wherein the optical lens is fashioned to control light emitted from the light source using refraction and total internal reflection.

According to another aspect of the present disclosure, a lighting assembly for illuminating a display case is provided. The lighting assembly includes an elongated frame and a plurality of modular inserts removably connected to the elongated frame. The plurality of modular inserts include a plurality of spacers and a plurality of LED modules, where the plurality of LED modules are spaced along the length of the elongated frame using the plurality of spacers. Each of said plurality of LED modules is removably coupled to adjacent LED modules electrically.

### BRIEF DESCRIPTION OF THE DRAWINGS

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure will be set forth in the following detailed description of the disclosure when considered in conjunction with the drawings, in which:

FIG. 1 is a plan view of a commercial refrigeration display case;

FIG. 2 is an exploded view of a lighting assembly;

FIG. 3 is a cross sectional view of a lighting assembly;

FIG. 4 is a perspective view of a light module;

FIG. 5 is a cross sectional view of the light module of FIG. 4;

FIG. 6 is a cross sectional view of a light module;

FIG. 7 is a perspective view of a spacer module;

FIG. 8 is an exploded view of a lighting assembly;

FIG. 9 is a cross sectional view of a lighting assembly;

FIG. 10 is a perspective view of a light module;

FIG. 11 is a cross sectional view of the light module of FIG. 10; and,

FIG. 12 is a cross sectional view of a light module.

### DETAILED DESCRIPTION

One or more embodiments or implementations are hereinafter described in conjunction with the drawings, where like reference numerals are used to refer to like elements throughout, and where the various features are not necessarily drawn to scale.

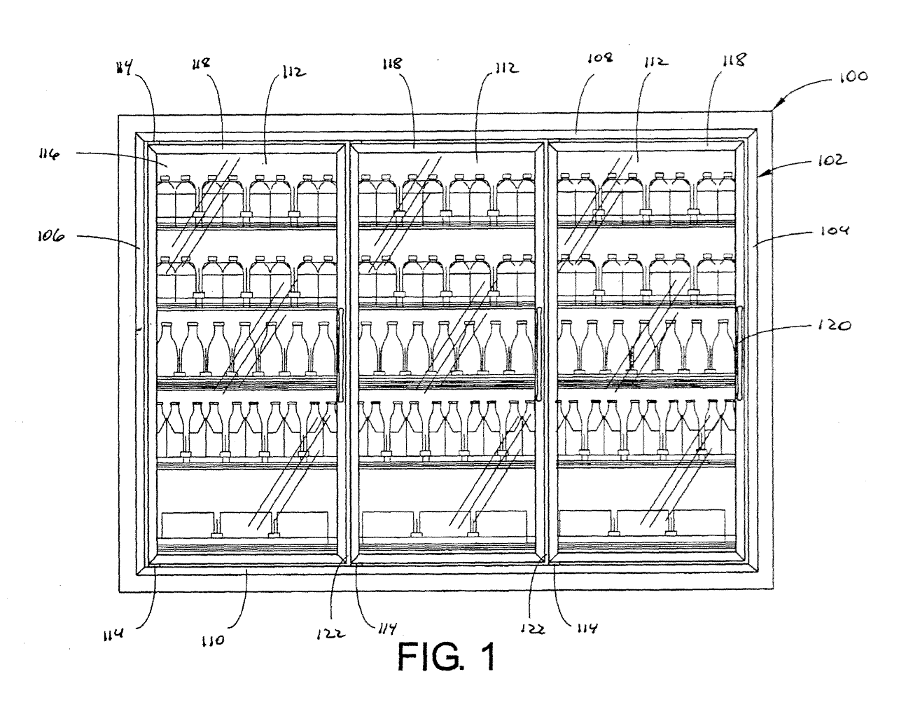

With reference to FIG. 1, a typical refrigerated display case 100 is illustrated. The refrigerated display case 100 has a door and frame assembly 102 mounted to a front portion of the case 100. The door and frame assembly 102 includes side frame members 104, 106 and top and bottom frame members 108, 110 that interconnect the side frame members 104, 106. Doors 112 mount to the frame members 104, 106, 108, 110 via hinges 114. The doors 112 include glass panels 116 retained in frames 118 and handles 120 may be provided on the doors. Mullions 122 mount to the top and bottom frame members 108, 110 to provide door stops and points of attachment for the doors 112 and/or hinges 114.

The lighting assemblies disclosed herein may suitably be employed within a display case, such as the refrigerated display case 100, as well as in a multitude of other applications. Further, the display case may employ different configurations than the refrigerated display case 100. For example, the display case may be a refrigerated display case lacking doors. As another example, the display case may be free-standing or a built-in display case.

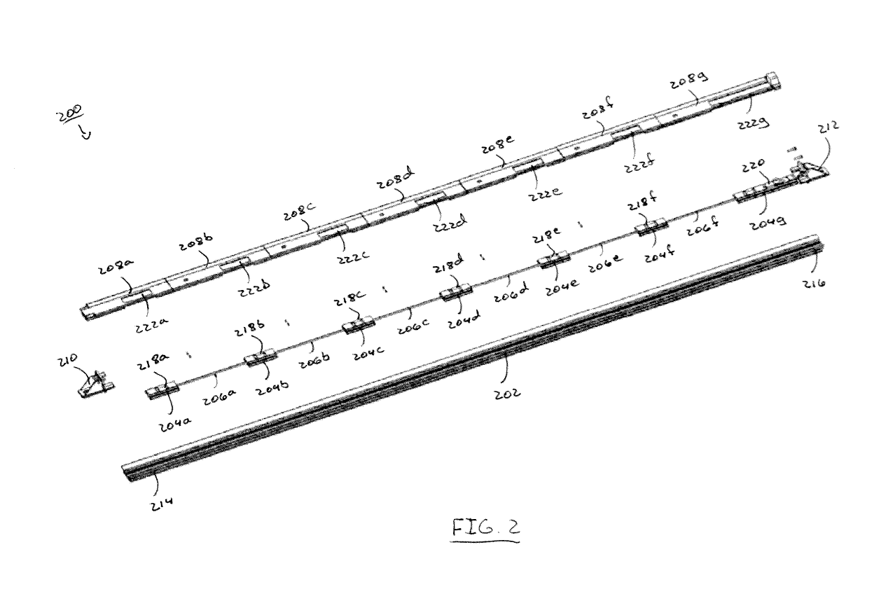

With reference to FIG. 2, an exploded view of a lighting assembly 200 is illustrated. The lighting assembly 200 may include an elongated frame 202, one or more modules 204, one or more electrical cables 206, one or more spacers 208, end caps 210, 212, and a cover (not shown). Suitably, the lighting assembly 200 mounts vertically to a standard mullion, such as the mullion 122 depicted in FIG. 1, and therefore may have a width that is substantially equal to a standard mullion.

The frame 202 substantially defines the body of the lighting assembly 200 and provides a structure on which to secure the modules 204 and/or the spacers 208. The modules 204 and/or the spacers 208 are hereafter referred to as the modular inserts. Suitably, the modular inserts are slidingly secured to the frame 202 via a channel defined by opposing grooves running along the length of the frame 202. In such embodiments, each of the modular inserts includes opposing tabs that interlock with the opposing grooves, thereby limiting the range of motion of the modular inserts to motion along the length of the frame 202. The end caps 210, 212 then prevent the modular inserts from sliding out of the frame 202.

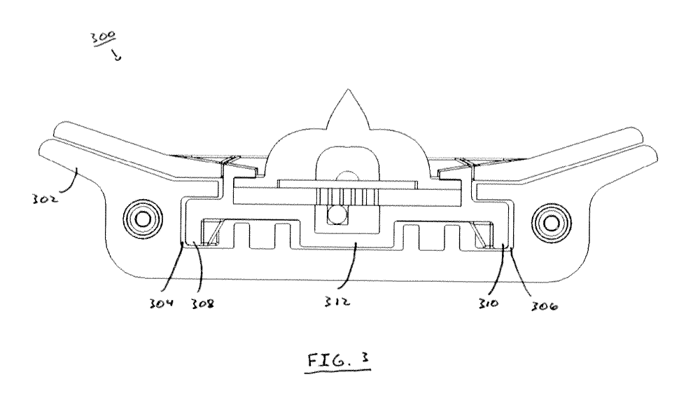

Referring to FIG. 3, a cross sectional view of a lighting assembly 300 illustrates the interlocking system of grooves and tabs. Therein, a frame 302 of the lighting assembly 300 includes opposing grooves 304, 306 extending along the length of the frame 302. Opposing tabs 308, 310 on a modular insert 312 then interlock with the grooves 304, 306, so as to limit motion of the modular insert 312 to motion along the length of the frame 302.

Referring back to FIG. 2, the frame 202 is preferably comprised of a polymeric material, so as to reduce costs associated with the lighting assembly 200. However, the frame 202 need not necessarily be polymeric, whereby the frame 202 may, for example, be comprised of a thermally conductive material, such as aluminum, so as to act as a heat sink and facilitate the transfer heat away from the lighting assembly 200.

The modules 204 are suitably white so as to reflect light away from the modules 204, but other colors are equally amenable. Further, the modules 204 are suitably comprised of a polymeric material, so as to reduce costs associated with the lighting assembly 200, but other materials equally amenable. For example, as with the frame 202, the modules 204 may be comprised of a thermally conductive material, such as aluminum, so as to act as a heat sink and facilitate the transfer heat away from the lighting assembly 200.

So that power may be transferred from one end 214, 216 of the lighting assembly 200 to the other end 214, 216 of the lighting assembly 200, the modules 204 may be interconnected with one or more electrical cables 206. The electrical cables 206 may run through grooves on the bottom of the modules 204 and/or the spacers 208. Additionally, or alternatively, the electrical cables 206 may be disposed within the modules 204 and/or the spacers 206. In such embodiments, each module and/or spacer preferably has an electrical cable running therethrough between a pair of connectors, where the connectors of adjacent modules and/or spacers are provisioned to mechanically couple to one another and electrically connect the individual electrical cables.

The modules 204 may include at least one of one or more light modules 218, one or more power modules 220, and the like. The light modules 218 may provide illumination to a display case and may include one or more light sources. Suitably, the light sources include one or more LEDs. The power modules 220 may provide illumination to a display case and/or provide power to the light modules 218. Suitably, the power modules 220 receive power from an external power source and are disposed on the distal ends 214, 216 of the frame 202, so as to easily receive power from the external power source. The power modules 220 may include one or more of a light module, a power regulating circuit, a power conditioning circuit, and the like.

The power regulating circuit regulates the flow of current through the modules 204 so as to allow the lighting assembly 200 to dynamically adapt to an increased load; for example, an additional light module. Preferably, this is accomplished with a simple DC-DC converter, but other means of accomplishing this are equally amenable.

The power conditioning circuit may convert alternating current voltage to a direct current voltage. For example, the power conditioning circuit may convert 120 or 240 volt alternating current voltage to a direct current voltage. The power conditioning circuit may additionally, or alternatively, correct for polarity of the incoming power so that the power supply wires that connect to the power module 220 can be connected without having to worry about which wire connects to which element of the power conditioning circuit.

The spacers 208 serve to orient the modules 204 within the frame 202 and suitably include openings 222 for receiving the modules 204. For example, a spacer module 208a may include an opening 222a for receiving a module 204a. The sizes of the openings 222 may vary from one spacer to another depending upon the size of the modules 204. In certain embodiments, one or more spacers without openings may additionally, or alternatively, be employed.

So as to equally space the modules 204 and provide a uniform lighting pattern, the spacers 208 may have equal lengths. However, the lengths of spacers 208 may vary from one spacer to another and uniform spacing of the modules 204 is not required. For example, it may be desirable to space the modules 204 closer together in the center of the lighting assembly 200 in order to increase illumination on the center shelves of a display case. In such an example, the spacers disposed in the center of the lighting assembly 200 may have shorter lengths than the spacers disposed at the periphery of the lighting assembly 200.

Like the modules 204, the spacers 208 are suitably white so as to reflect light away from the spacers 208, but other colors are equally amenable. Further, the spacers 208 are suitably comprised of a polymeric material, so as to reduce costs associated with the lighting assembly 200, but other materials are equally amenable. For example, the spacers 208 may be comprised of a thermally conductive material, such as aluminum.

The end caps 210, 212 are fastened to the distal ends 214, 216 of the frame 202 and serve to secure the modules 204 and/or the spacers 208 within the frame 202. Additionally, the end caps 210, 212 may provide a mounting structure to facilitate attachment of the lighting assembly 200 to a display case. However, the lighting assembly 200 may also be mounted to the display case by other means. For example, the frame 202 may be mounted directly to the mullion by way of mechanical fasteners, such as scews.

Although not shown, the lighting assembly 200 may include a cover that mounts to the frame 202 and includes a clear and/or translucent portion that allows light to pass therethrough. The translucent portion of the cover may be tinted to adjust the color of the light emitted by the lighting assembly 200.

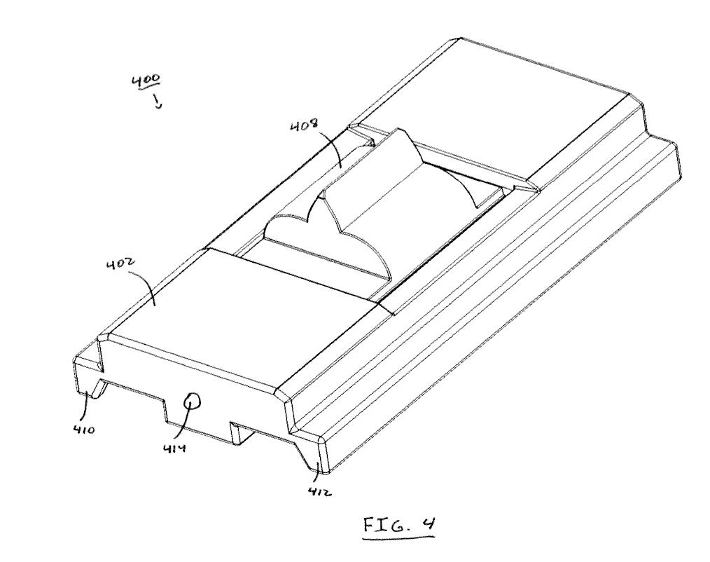

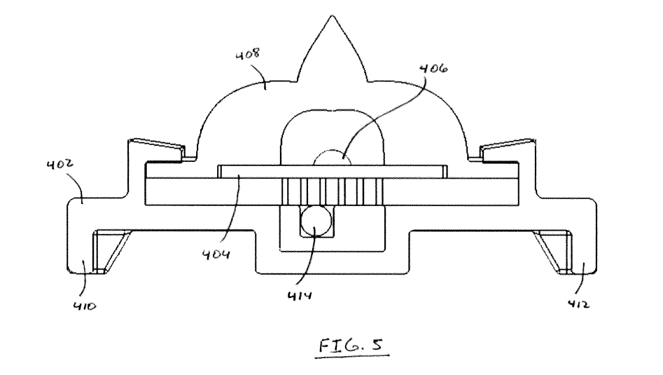

With reference to FIGS. 4 and 5, a light module 400 is illustrated. FIG. 4 is a perspective view of the light module 400, and FIG. 5 is a cross sectional view of the light module 400. As noted above, light modules provide illumination to a display case and may include one or more light sources, such as LEDs. The light module 400 may include a housing 402, a printed circuit board 404, one or more light sources 406, an optical lens 408, opposing tabs 410, 412, and a conduit 414.

The housing 402 is suitably white, so as to facilitate the reflection of light away from the housing 402. Further, the housing 402 is suitably comprised of a polymeric material, so as to reduce the cost and weight of the light module 400. However, the housing 402 need not necessarily be white and/or formed of a polymeric material. For example, the housing 402 may alternatively be formed of a thermally conductive material, such as aluminum.

The light sources 406 provide luminance to the display case employing the lighting assembly associated with the light module 400. Suitably, the light sources 406 include one or more LEDs. The light sources 406 may be selected to control Correlated Color Temperature (CCT), Color Rendering Index (CRI) and other like characteristics of light.

The printed circuit board 404 is disposed within the housing 402 and includes a lower surface opposite an upper surface, where the light sources 406 mount to the upper surface. The printed circuit board 404 may include a metal core printed circuit board (“MCPCB”), but other circuit boards are equally amenable. Further, the printed circuit board 404 may include a rectangular configuration extending along the length of the light module 400, but other configurations are equally amenable. Suitably, the printed circuit board 404 includes a plurality of traces electrically connecting the light sources 406 to the electrical power cables interconnecting the modules of the lighting assembly.

The optical lens 408 is disposed over and/or around the light sources 406. Suitably, the optical lens 408 directs light emitted from the light sources 406 such that a majority of the light is emitted to the sides of the optical lens 408. Advantageously, this allows the profile of the lighting assembly to be very thin, thereby precluding a consumer viewing the inside of the display case from seeing the optics and/or the light sources. The optic material of the optical lens 408 may be tinted to remove components of the light passing through the optical lens 408. Additionally, the optical lens 408 may include one or more of an anti-fog, an anti-glare, reflective coating and the like.

The optical lens 408 and the printed circuit board 404 are suitably secured to each other and the housing 402 by way of a plastic over mold, which defines the housing 402. However, other means of securing the optical lens 408, the printed circuit board 404 and the housing 402 are equally amenable. For example, said components may be secured together via tape, glue, mechanical fastener or the like.

The opposing tabs 410, 412 allow the light module 400 to be slidingly secured to the frame of the lighting assembly. Namely, as discussed above, the opposing tabs 410, 412 fit within grooves of the frame of the lighting assembly, thereby limiting motion of the light module 400 to motion along the length of the lighting assembly.

The conduit 414 is disposed within the housing 402 and extends along its length thereby providing a channel within which to place the electrical cables interconnecting modules. Suitably, the conduit 414 is large enough to receive one or more electrical cables interconnecting the modules of the lighting assembly. As noted above, the printed circuit board 404 is electrically coupled to the electrical cables so as to provide power to the light sources 406.

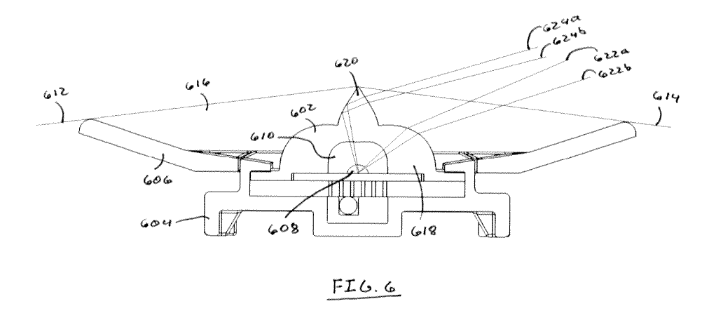

With reference to FIG. 6, an optical lens 602 of a light module 604 is illustrated using a cross sectional view of a spacer 606 having the light module 604 disposed therein. The light module 604, in addition to including the optical lens 602, includes a light source 608 encompassed by the optical lens 602, where there is an air gap 610 between the light source 608 and the optical lens 602.

As shown, visibility lines 612, 614 extend from the tip of the optical lens 602 to the periphery of the spacer 606. The visibility lines 612, 614 define a region 616 outside the view of a consumer looking in to the display case. This region 616 is hereinafter referred to as the visibility envelope. As noted above, consumer tests have shown that it is desirable to keep the optical lens 602 and the light source 608 within the visibility envelope.

So as to ensure the optical lens 602 and the light source 608 are within the visibility envelope 616, the light source 608 and the optical lens 602 are recessed within the spacer 606. As should be appreciated, this makes it more difficult to direct the light emitted from the light source 608 to the center of the display case. The optical lens 602 addresses this difficulty by making use of a combination of total internal reflection and refraction.

The optical lens 602 may include two primary areas: a base area 618 and a triangular area 620. The base area 618 facilitates refraction of light to the sides of the light source 608 and towards the items within the display case, as shown by light rays 622. However, because the light source 608 and the optical lens 602 are recessed, the amount of light reaching the center of the display case is limited. The triangular area 620 advantageously remedies this by facilitating total internal reflection to the center of the display case, as shown by light rays 624.

Because the optical lens comes close to the paramount of the visibility envelope 616, the optical lens 602 is not as hindered by the recess. As such, the angle of light extending from the triangular area 620 can be shallower than the angle of light extending from the base area 618. This advantageously allows a larger amount of light to be directed to the center of the display case than would otherwise be possible with convention optical lenses.

In view of the foregoing, the optical lens 602 allows the display case to be more uniformly lit than would otherwise be possible. Further, the optical lens 602 does this while at the same time keeping the optical lens 602 and the light source 608 within the visibility envelope, which, as noted above, consumers test have found desirable to consumers.

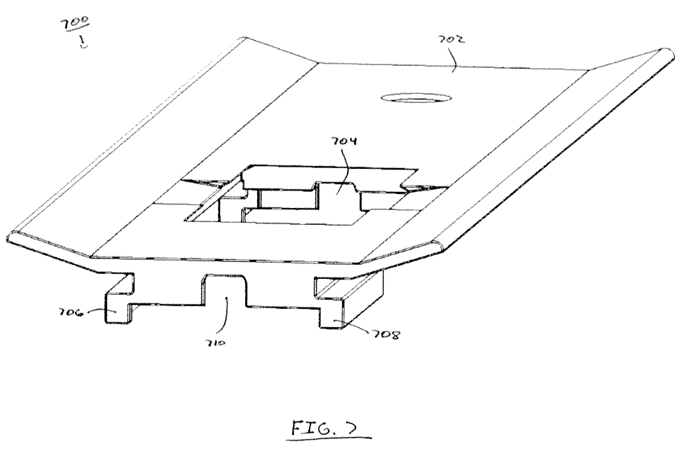

With reference to FIG. 7, a perspective view of a spacer 700 is illustrated. As noted above, spacer modules serve to orient modules. The spacer 700 may include a housing 702, an opening 704, opposing tabs 706, 708, and a groove 710.

The housing 702 is suitably white, so as to facilitate the reflection of light away from the housing 702. Further, the housing 702 is suitably comprised of a polymeric material, so as to reduce the cost and weight of the spacer 700.

The opening 704 is suitably disposed within the housing 702 and serves to receive and secure a light module. The size of the opening 704 may vary depending upon the size of the light module.

The opposing tabs 706, 708 allow the spacer 700 to be slidingly secured to the frame of the lighting assembly. Namely, as discussed above, the opposing tabs 706, 708 fit within grooves of the frame of the lighting assembly, thereby limiting motion of the spacer 700 to motion along the length of the lighting assembly.

The groove 710 extends along the length of the housing 702 thereby providing a channel within which to place the electrical cables interconnecting modules. Suitably, the groove 710 is large enough to receive one or more electrical cables interconnecting the modules of the lighting assembly.

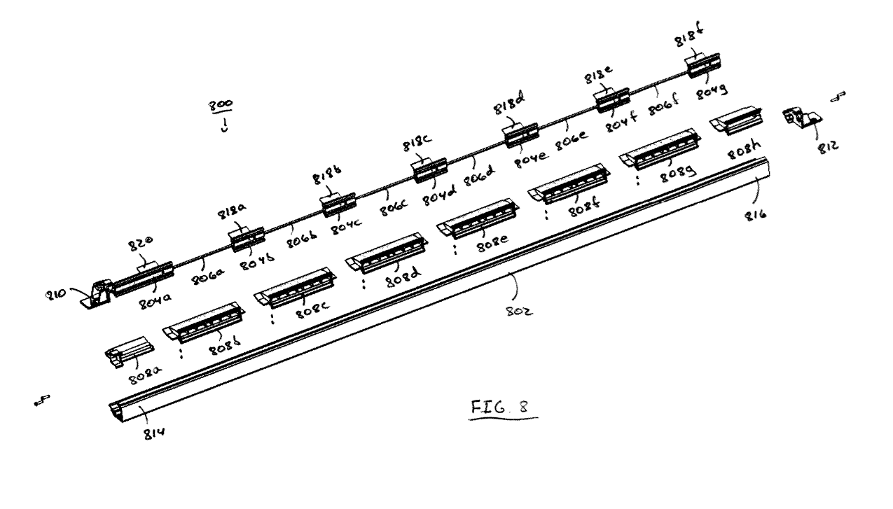

With reference to FIG. 8, an exploded view of a lighting assembly 800 is illustrated. The lighting assembly 800 is similar to the lighting assembly 200 described with reference to FIG. 2. However, this lighting assembly 800 is configured to be mounted vertically in a corner of a display case such that light is typically directed to only one side of the assembly 800. The lighting assembly 800 may include an elongated frame 802, one or more modules 804, one or more electrical cables 806, one or more spacers 808, end caps 810, 812, and a cover (not shown).

The frame 802 is suitably L-shaped. Further, the frame 802 substantially defines the lighting assembly 800 and provides a structure on which to secure the modules 804 and/or the spacers 808. The modules 804 and/or the spacers 808 are hereafter referred to as the modular inserts. Suitably, the modular inserts are slidingly secured to the frame 802 via a channel defined by opposing grooves running along the length of the frame 802. In such embodiments, each of the modular inserts includes opposing tabs that interlock with the opposing grooves, thereby limiting the range of motion of the modular inserts to motion along the length of the frame 802. The end caps 810, 812 then prevent the modular inserts from sliding out of the frame 802.

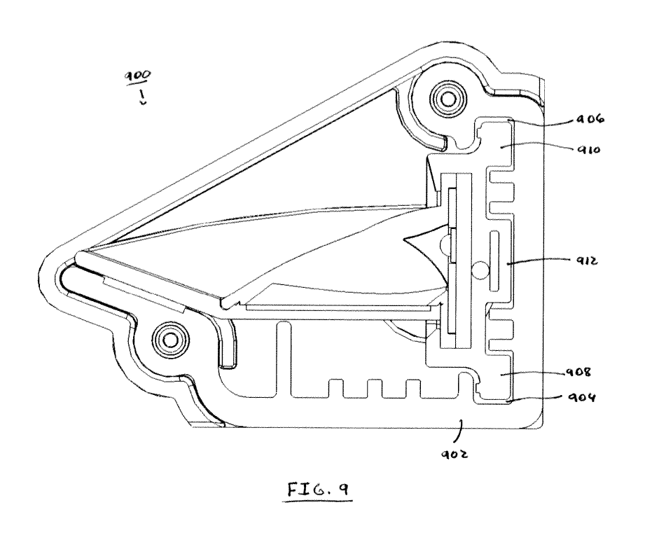

Referring to FIG. 9, a cross sectional view of a lighting assembly 900 illustrates the interlocking system of grooves and tabs. Therein, a frame 902 of the lighting assembly 900 includes opposing grooves 904, 906 extending along the length of the frame 902. Opposing tabs 908, 910 on a modular insert 912 then interlock with the grooves 904, 906, so as to limit motion of the modular insert 912 to motion along the length of the frame 902.

Referring back to FIG. 8, the frame 802 is preferably comprised of a polymeric material, so as to reduce costs associated with the lighting assembly 800. However, the frame 802 need not necessarily be polymeric, whereby the frame 802 may, for example, be comprised of a thermally conductive material, such as aluminum, so as to act as a heat sink and facilitate the transfer heat away from the lighting assembly 800.

The modules 804 are suitably comprised of a polymeric material, so as to reduce costs associated with the lighting assembly 800, but other materials equally amenable. For example, as with the frame 802, the modules 804 may be comprised of a thermally conductive material, such as aluminum, so as to act as a heat sink and facilitate the transfer heat away from the lighting assembly 800.

So that power may be transferred from one end 814, 816 of the lighting assembly 800 to the other end 814, 816 of the lighting assembly 800, the modules 804 may be interconnected with one or more electrical cables 806. The electrical cables 806 may run through grooves on the modular inserts. Alternatively, the electrical cables 806 may be disposed within the modular inserts. In such embodiments, each modular insert preferably has an electrical cable running therethrough between a pair of connectors, where the connectors of adjacent modular inserts are provisioned to mechanically couple to one another and electrically connect the individual electrical cables.

The modules 804 may include at least one of one or more light modules 818, one or more power modules 820, and the like. The light modules 818 may provide illumination to a display case and may include one or more light sources. Suitably, the light sources include one or more LEDs. The power modules 820 may provide illumination to a display case and/or provide power to the light modules 818. Suitably, the power modules 820 receive power from an external power source and are disposed on the distal ends 814, 816 of the frame 802, so as to easily receive power from the external power source. The power modules 820 may include one or more of a light module, a power regulating circuit, a power conditioning circuit, and the like.

The power regulating circuit regulates the flow of current through the modules 804 so as to allow the lighting assembly 800 to dynamically adapt to an increased load; for example, an additional light module. Preferably, this is accomplished with a simple DC-DC converter, but other means of accomplishing this are equally amenable.

The power conditioning circuit may convert alternating current voltage to a direct current voltage. For example, the power conditioning circuit may convert 120 or 240 volt alternating current voltage to a direct current voltage. The power conditioning circuit may additionally, or alternatively, correct for polarity of the incoming power so that the power supply wires that connect to the power module 820 can be connected without having to worry about which wire connects to which element of the power conditioning circuit.

The spacers 808 serve to orient the modules 804 within the frame 802. Suitably, the spacers 808 alternate with the modules 804 along the length of the frame 802 and have equal lengths so as to equally space the modules 804 and provide a uniform lighting pattern. However, the lengths of spacers 808 may vary from one spacer to another and uniform spacing of the modules 804 is not required. For example, it may be desirable to space the modules 804 closer together in the center of the lighting assembly 800 in order to increase illumination on the center shelves of a display case. In such an example, the spacers disposed in the center of the lighting assembly 800 may have shorter lengths than the spacers disposed at the periphery of the lighting assembly 800.

The spacers 808 are suitably white so as to reflect light away from the spacers 808, but other colors are equally amenable. Further, the spacers 808 are suitably comprised of a polymeric material, so as to reduce costs associated with the lighting assembly 800, but other materials equally amenable. For example, the spacers 808 may be comprised of a thermally conductive material, such as aluminum. In certain embodiments, when the end of a spacer is adjacent to a module, the spacers 808 are shaped as module reflectors to help reflect light away from the lighting assembly. Module reflectors are discussed below.

The end caps 810, 812 are fastened to the distal ends 814, 816 of the frame 802 and serve to secure the modular inserts (i.e., the one or more of the modules 804, the spacers 808 and the reflectors 810) within the frame 802. Additionally, the end caps 810, 812 provide a mounting structure to facilitate attachment of the lighting assembly 800 to a display case. It should be appreciated, however, that the lighting assembly 800 can be mounted to the display case by other means. For example, the frame 802 may be mounted directly to the mullion by way of mechanical means.

Although not shown, the lighting assembly 800 may include a cover that mounts to the frame 802 and includes a clear and/or translucent portion that allows light to pass therethrough. The translucent portion of the cover may be tinted to adjust the color of the light emitted by the lighting assembly 800.

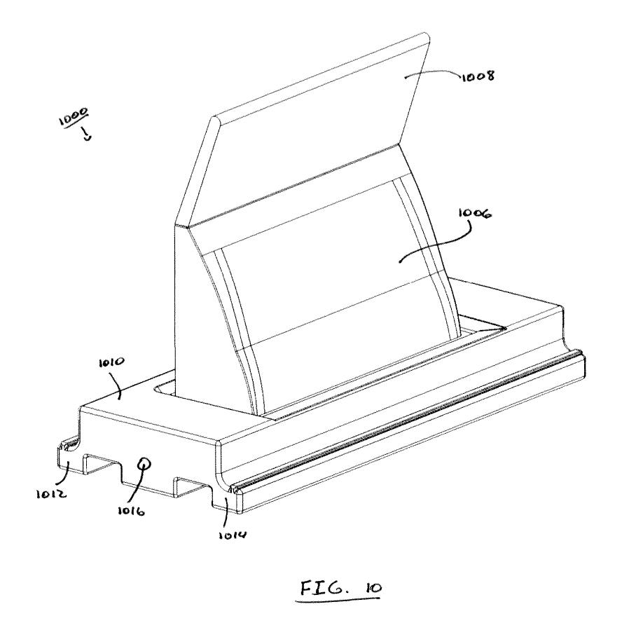

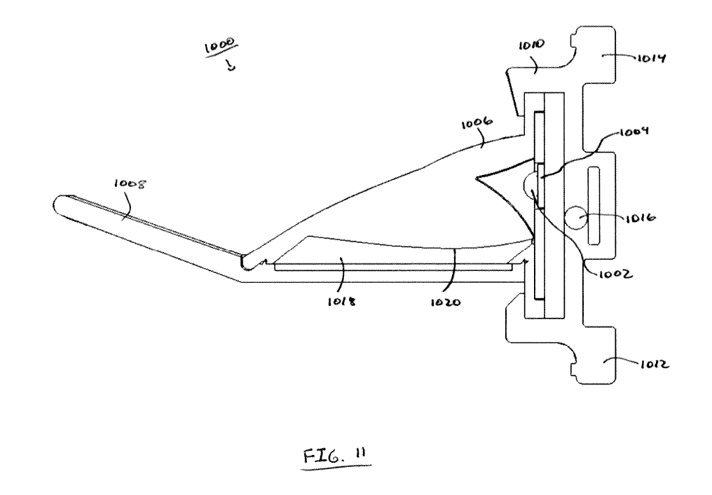

With reference to FIGS. 10 and 11, a light module 1000 is illustrated. FIG. 10 is a perspective view of the light module 1000, and FIG. 11 is a cross sectional view of the light module 1000. As noted above, light modules provide illumination to a display case and may include one or more light sources, such as LEDs. The light module 1000 may include one or more light sources 1002, a printed circuit board 1004, an optical lens 1006, a reflector 1008, a housing 1010, opposing tabs 1012, 1014, and a conduit 1016.

The light sources 1002 provide luminance to the display case employing the lighting assembly associated with the light module 1000. Suitably, the light sources include one or more LEDs, The light sources 1002 may be selected to control Correlated Color Temperature (CCT), Color Rendering Index (CRI) and other like characteristics of light.

The printed circuit board 1004 is disposed within the housing 1010 and includes a lower surface opposite an upper surface, where the light sources 1002 mount to the upper surface. The printed circuit board 1004 may include a metal core printed circuit board (“MCPCB”), but other circuit boards are equally amenable. Further, the printed circuit board 1004 may include a rectangular configuration extending along the length of the light module, but other configurations are equally amenable. Suitably, the printed circuit board 1004 includes a plurality of traces electrically connecting to the light sources 1002 to the electrical power cables interconnecting the modules of the lighting assembly.

The optical lens 1006 is disposed over and/or around the light sources 1002. Suitably, the optical lens 1006 directs light emitted from the light sources 1002 such that a majority of the light is emitted to the sides of the optical lens 1006. Advantageously, this allows the profile of the lighting assembly to be very thin, thereby precluding a consumer viewing the inside of the display case from seeing the optics and/or the light source. The optic material of the optical lens 1006 may be tinted to remove components of the light passing through the optical lens 1006. Additionally, the optical lens 1006 may include one or more of an anti-fog, an anti-glare, reflective coating and the like.

The reflector 1008 a reflects light generated by the light sources 1002 to the center of the display case. Suitably, the reflector 1008 is bonded to the optical lens 1006 by means of sonic weld, vibration weld, adhesive, or the like to define an air gap 1018. As will be seen, the optical lens makes use of total internal reflection along a boundary 1020 abutting this air gap. This bonding protects the boundary 1020 from condensation buildup of any material (e.g., food elements from spills) that would frustrate total internal reflection. This is important because the boundary 1020 is not exposed and cannot be cleaned.

So as to facilitate the reflection of light away from the reflector 1008, the reflector 1008 is suitably white. Further, the reflector 1008 is suitably comprised of a polymeric material, so as to reduce the cost and weight of the light module 1000. However, the reflector 1008 need not necessarily be white and/or formed of a polymeric material. For example, the reflector 1008 may alternatively be formed of a thermally conductive material, such as aluminum.

The housing 1010 holds the optical lens 1006, the printed circuit board 1004, and the reflector 1008 together. To accomplish this, the housing 1010 suitably includes a plastic over mold. However, other means of securing the optical lens 1006, the printed circuit board 1004, and the reflector 1008 to the housing 1010 are equally amenable. For example, the optical lens 1006, the printed circuit board 1004, and the reflector 1008 may be secured to the housing via tape, glue, mechanical fastener or the like. So as to reduce its visibility to an onlooker of the display case, the housing 1010 is suitably black. Further, as with the reflector 1008, the housing 1010 is suitably comprised of a polymeric material, so as to reduce the cost and weight of the light module 1000.

The opposing tabs 1012, 1014 allow the light module 1000 to be slidingly secured to the frame of a lighting assembly. Namely, as discussed above, the opposing tabs 1012, 1014 fit within grooves of the frame of the lighting assembly, thereby limiting motion of the light module 1000 to motion along the length of the lighting assembly.

The conduit 1016 is disposed within the housing 1010 and extends along its length thereby providing a channel within which to place the electrical cables interconnecting modules. Suitably, the conduit 1016 is large enough to receive one or more electrical cables interconnecting the modules of the lighting assembly. As noted above, the printed circuit board 1004 is electrically coupled to the electrical cables so as to provide power to the light source 1002.

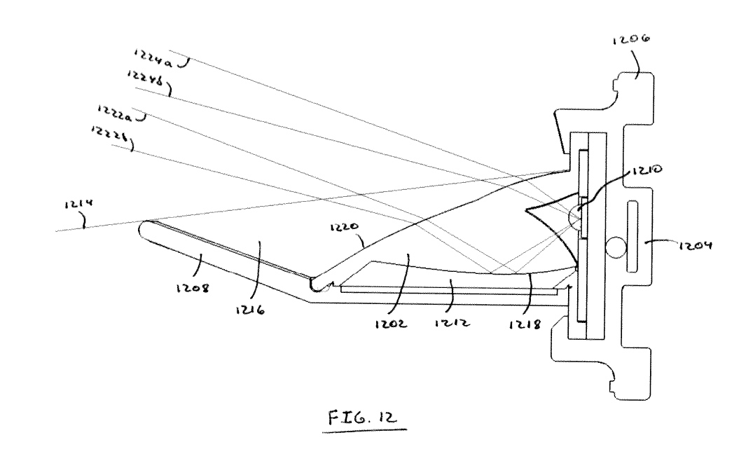

With reference to FIG. 12, an optical lens 1202 of a light module 1204 is illustrated using a cross sectional view of the light module 1204. The light module 1204, in addition to including the optical lens 1202, includes a housing 1206, a reflector 1208 and a light source 1210 encompassed by the optical lens 1202, where there is an air gap 1212 between the light source 1210 and the optical lens 1202.

As shown, a visibility line 1214 extends from the optical lens 1202 to the periphery of the light module 1204. The visibility line 1214 defines a region 1216 outside the view of a consumer looking in to the display case. This region 1216 is hereinafter referred to as the visibility envelope. Consumer tests have shown that it is desirable to keep the optical lens 1202 and the light source 1210 within the visibility envelope 1216. In certain embodiments, the housing 1206, which generally falls outside the visibility envelopment 1216, is black so as to make it less visible, whereas the reflector 120, which falls within the visibility envelope 1216, is suitably white.

So as to ensure the optical lens 1202 and the light source 1210 are within the visibility envelope 1216, the light source 1210 and the optical lens 1202 are recessed within the light module 1204. As should be appreciated, the reflector 1208 of the light module 1204 helps defines the recess. While recessing the light source 1210 and the optical lens 1202 helps keep the light source 1210 and the optical lens 1202 in the visibility envelope 1216, it also makes it more difficult to direct the light emitted from the light source 1210 to the center of the display case.

The optical lens 1202 addresses this difficulty by making use of a combination of total internal reflection and refraction. Most of the light given off by the light source 1210 is originally directed to a first boundary 1218. This light reflects off the first boundary 1218 and then refracts towards the center of the display case via a second boundary 1220, as shown by light rays 1222. The remaining light given off by the light source 1210 is originally directed to the second boundary 1220 and refracts to the display case, as shown by light rays 1224. This light is spread from close to the light module 1204 to close to the center of the display case depending upon where it crosses along the length of the second boundary. For example, the light rays going left (as oriented by FIG. 12) are directed toward the center of the display case while the light rays going up are directed closer to the light module 1204.

In view of the foregoing, the optical lens 1202 allows the display case to be more uniformly lit than would otherwise be possible. Further, the optical lens 1202 does this while at the same time keeping the optical lens 1202 and the light source 1210 within the visibility envelope 1216, which, as noted above, consumers test have found desirable to consumers.

The lighting assemblies have been described with reference to the disclosed embodiments. Furthermore, components that are described as a part of one embodiment can be used with other embodiment. The invention is not limited to only the embodiments described above. Instead, the invention is defined by the appended claims and the equivalents thereof.

1. A lighting assembly for illuminating a display case, said assembly comprising:
an elongated frame; and,
a plurality of modular inserts removably connected to the elongated frame, wherein the plurality of modular inserts include a plurality of light modules, wherein each of the plurality of light modules is removably coupled to adjacent light modules electrically.

2. The assembly of claim 1, wherein the plurality of modular inserts includes at least one spacer.

3. The assembly of claim 2, wherein the each of the plurality of light modules is disposed within one of the at least one spacer.

4. The assembly of claim 1, wherein the each of the plurality of light modules is in electrical communication with each other light module.

5. The assembly of claim 1, wherein each of the plurality of modular inserts receives power from an external power supply electrically connected to one of the plurality of modular inserts disposed at a distal end of the lighting assembly.

6. The assembly of claim 1, wherein the plurality of modular inserts includes a power module disposed on a distal end of the lighting assembly.

7. The assembly of claim 1, wherein the plurality of modular inserts includes a plurality of spacers, wherein the plurality of light modules and the plurality of spacers alternate along the length of the lighting assembly.

8. The assembly of claim 1, wherein the each of the plurality of light modules includes at least one light source and a lens, wherein the lens directs a majority of light generated by the at least one light source perpendicular to the normal of a base upon which the at least one light source rests.

9. The assembly of claim 1, wherein the each of the plurality of light modules includes at least one light source, wherein the at least one light source includes at least one LED.

10. A lighting assembly for illuminating a display case, wherein the lighting assembly is mounted to the display case and includes a visibility envelope within which an onlooker of the display case cannot see, the assembly comprising:
a light source; and,
an optical lens disposed over and/or around the light source, wherein the optical lens is disposed exclusively within the visibility envelope, wherein the optical lens is fashioned to control light emitted from the light source using refraction and total internal reflection.

11. The lighting assembly of claim 10, wherein the optical lens is recessed within a housing and light emitted from the light source is reflected off the housing to light an area proximate the lighting assembly.

12. The lighting assembly of claim 10, wherein light emitted from the light source is directed substantially perpendicular to a normal of a base upon which the light source rests.

13. The lighting assembly of claim 10, wherein the light source is an LED.

14. The lighting assembly of claim 10, wherein the optical lens defines a cavity between the light source and the optical lens.

15. The lighting assembly of claim 10, wherein the optical lens includes a first portion and a second portion, wherein the first portion is disposed above the second portion and facilitates total internal reflection.

16. A lighting assembly for illuminating a display case, wherein the lighting assembly is mounted to the display case and includes a visibility envelop within which an onlooker of the display case cannot see, the assembly comprising:
an elongated frame provisioned to receive modular inserts; and,
at least one modular insert operatively connected to the elongated frame, wherein the at least one modular insert includes a light module having an optical lens and a light source, wherein the optical lens is disposed over and/or around the light source and exclusively within the visibility envelope, wherein the optical lens is fashioned to control light emitted from the light source using refraction and total internal reflection.

17. The lighting assembly of claim 16, wherein the light module further includes a housing, wherein the optical lens is recessed within the housing and light emitted from the light source is reflected off the housing to light an area proximate the lighting assembly.

18. The lighting assembly of claim 16, wherein the light source is an LED.

19. The lighting assembly of claim 16, wherein the at least one modular insert includes a second light module, wherein the at least one light module and the second light module are removably coupled electrically.

20. The assembly of claim 16, wherein each of the at least one modular insert receives power from an external power supply electrically coupled to one of the at least one modular insert disposed at a distal end of the lighting assembly.

21. A lighting assembly for illuminating a display case, said lighting assembly comprising:
an elongated frame; and,
a plurality of modular inserts removably connected to the elongated frame, wherein said plurality of modular inserts include a plurality of spacers and a plurality of LED modules, wherein said plurality of LED modules are spaced along the length of the elongated frame using the plurality of spacers, wherein each of said plurality of LED modules is removably coupled to adjacent LED modules electrically.
